(19) United States
(12) Patent Application Publication
(10) Pub. No.: US 2022/0044675 A1
(43) Pub. Date: Feb. 10, 2022

(54) METHOD FOR GENERATING CAPTION FILE THROUGH URL OF AN AV PLATFORM

(71) Applicant: National Chiao Tung University, Hsinchu (TW)

(72) Inventors: Sin Horng CHEN, Hsinchu (TW); Yuan Fu LIAO, Hsinchu (TW); Yih Ru WANG, Hsinchu (TW); Shaw Hwa HWANG, Hsinchu (TW); Bing Chih YAO, Hsinchu (TW); Cheng Yu YEH, Hsinchu (TW); You Shuo CHEN, Hsinchu (TW); Yao Hsing CHUNG, Hsinchu (TW); Yen Chun HUANG, Hsinchu (TW); Chi Jung HUANG, Hsinchu (TW); Li Te SHEN, Hsinchu (TW); Ning Yun KU, Hsinchu (TW)

(21) Appl. No.: 16/986,307

(22) Filed: Aug. 6, 2020

(51) Int. Cl. G10L 15/187; H04L 29/08; H04L 29/06; G10L 15/02; G10L 25/18; G10L 15/16; G10L 15/30; G10L 15/22; G10L 15/18

(52) U.S. Cl. CPC G10L 15/187; H04L 67/02; H04L 65/60; G10L 15/02; G10L 2015/025; G10L 15/16; G10L 15/30; G10L 15/22; G10L 15/1822; G10L 25/18

(57) ABSTRACT

The present invention provides a method for generating caption file through URL of an AV platform. By using various websites (such as YouTube, Instagram, Facebook, Twitter) for being inputted with the URL of a desired AV Platform and downloading a required AV file and inputting to an ASR (Automatic Speech Recognition) server according to the present invention. A speech recognition system in the ASR server can abstract an audio file from the AV file for a system operation to get a required caption file. Artificial Neural Networks are used in the present invention.

### FIELD OF THE INVENTION

The present invention relates to a method for generating caption file, and more particularly to a method for generating caption file through URL of an AV platform.

### BACKGROUND OF THE INVENTION

The current method of audio-video (AV) platform for generating caption file is to listen to its audio directly in an artificial way, and then record it verbatim to form a caption file and play it with the video film.

This artificial method is not efficient and cannot form caption files in real time. For users of audio-video platforms, it cannot achieve the effect of real-time assistance.

Today AI (Artificial Intelligence) is commonly used. It is very convenient for users of the audio-video platform to apply AI methods (such as artificial neural networks) to the current audio-video platform to generate audio caption files.

### SUMMARY OF THE INVENTION

The object of the present invention is to provide a method for generating caption file through URL of an AV platform, so as to form caption files effectively for audio-video files in real time. The method of the present invention is described below.

An automatic speech recognition (ASR) server according to the present invention first parses the URL descriptions given by the user and finds a relevant audio-video platform, then sends an HTTP request to the web application interface provided by the web server of the audio-video platform to obtain an HTTP reply of the web server.

Parse the content in the HTTP reply to obtain the URL of an AV (Audio-Video) file, and download the AV file.

Abstract an audio track in the AV file to obtain an audio sample, then send it to a speech recognition system for processing, and then generate a caption file.

The speech recognition system includes a pre-processing step for audio, a step for extracting speech feature parameters, a phoneme recognition step, and a sentence decoding step. Artificial neural networks are used in both the phoneme recognition step and the sentence decoding step.

### BRIEF DESCRIPTION OF THE DRAWINGS

FIG. 1 shows schematically a diagram for describing the whole system according to the present invention.

FIG. 2 show schematically the steps of an ASR server for requesting and downloading an AV streaming according to the present invention.

FIG. 3 shows schematically a flow chart of the ASR server according to the present invention.

FIG. 4 shows schematically a sentence breaking mechanism of the speech recognition system according to the present invention.

FIG. 5 shows schematically a flow chart for analyzing sentences to generate caption files by the speech recognition system according to the present invention.

### DETAILED DESCRIPTIONS OF THE PREFERRED EMBODIMENTS

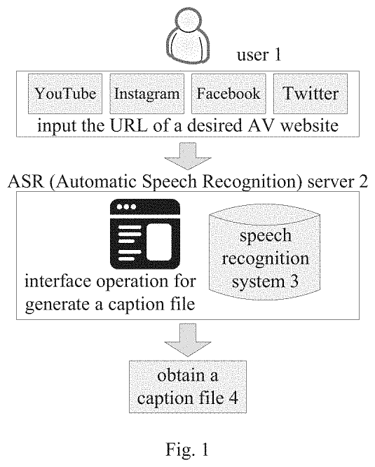

FIG. 1 shows schematically a diagram for describing the whole system according to the present invention. A user 1 uses various websites (such as YouTube, Instagram, Facebook, Twitter) to input the URL of a desired AV website for downloading a desired AV file and then inputing to an ASR server 2 according to the present invention. A speech recognition system 3 in the ASR server 2 abstracts an audio file from the AV file for a system operation to obtain a desired caption file 4.

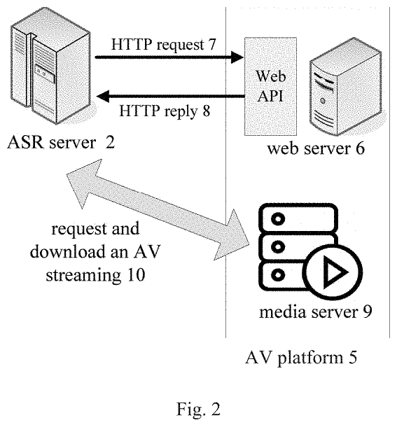

FIG. 2 show schematically the steps of the ASR server 2 for requesting and downloading an AV streaming according to the present invention. The ASR server 2 sends an HTTP request 7 to a web server 6 of an audio-video platform 5 to obtain an HTTP reply 8 of the web server 6. Then the ASR server 2 requests a media server 9 of the audio-video platform 5 for downloading an audio-video streaming 10.

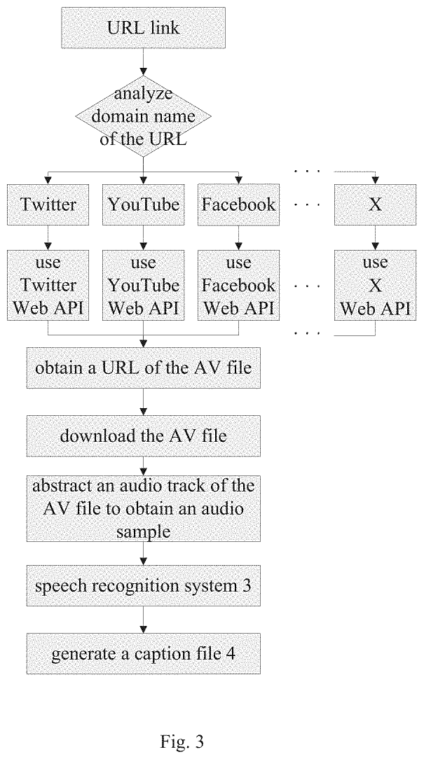

FIG. 3 further describes the flow chart of the ASR server 2 according to the present invention. Describing from top to bottom, a URL link given by a user is first analyzed, it maybe one of the Twitter, YouTube or Facebook platforms. After confirming the platform, the ASR server 2 sends an HTTP request 7 to a Web API of the web server 6 of the audio-video platform 5 to obtain an HTTP reply 8 of the web server 6 as shown in FIG. 2. Then the HTTP reply 8 is analyzed for further obtaining a URL of the desired AV file, downloading the desired AV file, abstracting an audio track in the AV file to obtain an audio sample, then send it to a speech recognition system 3 for processing, and then generate a caption file 4.

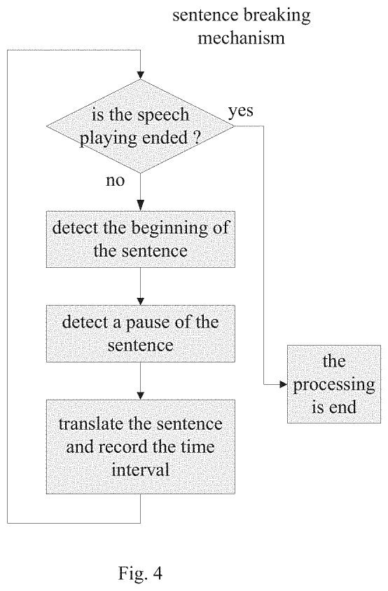

A sentence breaking mechanism in the speech recognition system 3 is described in FIG. 4. Describing from top to bottom, firstly judge if the speech playing is ended. If the speech playing is not ended, detecting the beginning of the sentence, and then detecting a pause of the sentence, thereafter translating the sentence and recording the time interval, go back to judge if the speech playing is ended, if not ended, then repeat to translate, otherwise the processing is ended to form a caption file 4.

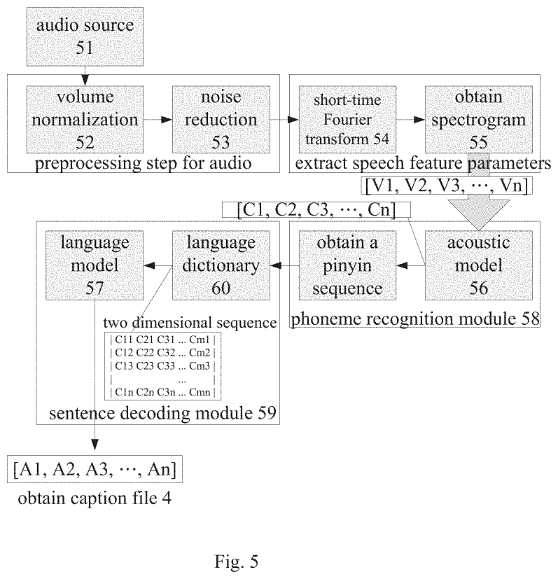

FIG. 5 shows schematically a flow chart for analyzing sentences to generate caption files by the speech recognition system 3 according to the present invention. The audio source 51 is the sentence. Firstly it is processed by volume normalization 52, and then by noise reduction 53, the two steps belong to the pre-processing step for audio.

Thereafter a Short-Time Fourier Transform 54 is processed to obtain a Spectrogram 55, this step is for extracting speech feature parameters. Feature parameters are used for express material or phenomenon characteristics. Take Chinese pronunciation as an example, a Chinese pronunciation can be cut into two parts, i.e. an initial and a final. The two parts uses the Short-Time Fourier Transform 54 to obtain the Spectrogram 55, and get the feature values [V1, V2, V3, . . . , Vn].

The speech recognition system 3 has two major models, i.e. acoustic model 56 and language model 57, as shown in FIG. 5. The phoneme recognition module 58 in FIG. 5 inputs [V1, V2, V3, . . . , Vn] into the acoustic model 56 to obtain a pinyin sequence [C1, C2, C3, . . . , Cn] for being inputted into the sentence decoding module 59.

The phoneme recognition module 58 recognizes for Chinese by initiala and finals (i.e. consonants and vowels in English), and inputs [V1, V2, V3, . . . , Vn] into the acoustic model 56 to obtain a pinyin sequence [C1, C2, C3, . . . , Cn]. The acoustic model 56 is an artificial neural network.

The sentence decoding module 59 includes a language dictionary 60 and a language model 57. Since each pinyin in Chinese may represent different words, the language dictionary 60 is used to spread [C1, C2, C3, . . . , Cn] into a two dimensional sequence as below:

| | | | | |
|---|---|---|---|---|
| \|C11 | C21 | C31 | . . . | Cm1 \| |
| \|C12 | C22 | C32 | . . . | Cm2 \| |
| \|C13 | C23 | C33 | . . . | Cm3 \| |
| \|. . . | . . . | . . . | . . . | . . . \| |
| \|C1n | C2n | C3n | . . . | Cmn \| |

For example, [ma, hua, teng] can be spreaded into a two dimensional sequence of 3×n

| | | | | |
|---|---|---|---|---|
| \| | [symbol] , | [symbol] , | [symbol] , | \| |
| \| | [symbol] , | [symbol] , | [symbol] , | \| |
| \| | [symbol] , | [symbol] , | [symbol] , | \| |
| \| | . . . | . . . | . . . | \| |

The above two dimensional sequence of 3×n are inputted into the language model 57 for being judged as | [symbol] |, instead of | [symbol] | or | [symbol] |, so as to form a final output [A1, A2, A3, . . . , An], i.e. the caption file 4. The language model 57 is an artificial neural network.

[symbol] is a Chinese name with pinyin (ma hua teng), he ranked 20th in Forbes' 2019 Billionaires List, with assets reaching 38.8 billion U.S. dollars.

[symbol] means (hemp flower pain), [symbol] means (hemp flower rattan), both pinyin (ma hua teng), but no special meaning.

The scope of the present invention depends upon the following claims, and is not limited by the above embodiments.

What is claimed is:

1. A method for generating caption file through URL of an AV platform, comprising steps as below:
(a) a server of an automatic speech recognition first parses a URL description given by a user and finds a relevant AV (audio-video) platform;
(b) sending an HTTP request to a web application interface provided, by a web server of the AV platform to obtain an HTTP reply of the web server;
(c) parsing a content in the HTTP reply to obtain a URL of an AV file, and download the AV file;
(d) abstracting an audio track in the AV file to obtain an audio sample, then send the audio sample to a speech recognition system for processing, and then generate a caption file.

2. The method for generating caption file through URL of an AV platform according to claim 1, wherein the speech recognition system has a sentence breaking mechanism, firstly judging if a speech playing is ended. If the speech playing is not ended, detecting a beginning of a sentence, and then detecting a pause of the sentence, thereafter translating the sentence and recording a time interval, go back to judge if the speech playing is ended, if not ended, then repeat to translate, otherwise a processing is ended to form a caption file.

3. The method for generating caption file through URL of an AV platform according to claim 1, wherein the speech recognition system includes a pre-processing step for audio, a step for extracting speech feature parameters, a phoneme recognition step, and a sentence decoding step.

4. The method for generating caption file through URL of an AV platform according to claim 3, wherein the pre-processing step for audio includes a step for volume normalization and a step for noise reduction.

5. The method for generating caption file through URL of an AV platform according to claim 3, wherein the step for extracting speech feature parameters uses a Short-Time Fourier Transform to obtain a Spectrogram.

6. The method for generating caption file through URL of an AV platform according to claim 5, wherein the phoneme recognition step includes an acoustic model, the acoustic model is an artificial neural network for being inputted with the Spectrogram to obtain a pinyin sequence.

7. The method for generating caption file through URL of an AV platform according to claim 6, wherein the inentence decoding step includes a language dictionary and a language model, the language model is an artificial neural network.

8. The method for generating caption file through URL of an AV platform according to claim 7, wherein the language dictionary is used to spread the pinyin sequence into a two dimensional sequence.

9. The method for generating caption file through URL of an AV platform according to claim 8, wherein the language model is used for interpreting the two dimensional sequence into the caption file.
